(19) United States
(12) Patent Application Publication
(10) Pub. No.: US 2011/0188913 A1
(43) Pub. Date: Aug. 4, 2011

(54) Image Forming Apparatus

(75) Inventor: Yosuke AOI, Nagoya-shi (JP)

(73) Assignee: BROTHER KOGYO KABUSHIKI KAISHA, Nagoya-shi (JP)

(21) Appl. No.: 13/013,303

(22) Filed: Jan. 25, 2011

(30) Foreign Application Priority Data
Jan. 29, 2010 (JP) 2010-017866

(51) Int. Cl. G03G 21/00

(52) U.S. Cl. 399/388

(57) ABSTRACT

An image forming apparatus that can form images on both surfaces of a recording medium is provided. The apparatus includes an image forming unit that forms an image on a recording medium, a switchback roller that switches back the recording medium fed from the image forming unit, and first and second feed portions. The first feeding portion may include a feed roller assembly that feeds the recording medium in a switchback direction while moving the recording medium to a first side in a widthwise direction perpendicular to the switchback direction. The second feeding portion may feed the recording medium fed by the first feeding portion toward the image forming unit.

### CROSS REFERENCE TO RELATED APPLICATION

This application claims priority from Japanese Patent Application No. 2010-017866, filed on Jan. 29, 2010, the entire subject matter of which is incorporated herein by reference.

### FIELD

Aspects of the invention relate to an image forming apparatus configured to form images on both sides of a recording medium.

### BACKGROUND

A known image forming apparatus may be configured to form images on both sides of a recording sheet. The image forming apparatus may include an image forming unit, ejection rollers, and a feed unit. When an image is formed on a second surface of the recording sheet whose first surface already has an image thereon, the ejection rollers feed the recording sheet in a sheet ejection direction and reverse the direction of rotation halfway to guide the recording sheet in such a manner that the recording sheet is drawn into the feed unit that extends vertically of the image forming apparatus. The image forming apparatus further includes a reverse feed unit (a duplexer) extending in a front-rear direction of the image forming apparatus for guiding the recording sheet fed from the feed unit toward the image forming unit again.

### SUMMARY

In the image forming apparatus structured above, it may be difficult to feed a recording medium in an intended direction (e.g. straight) in the feed unit due to factors such as dimensional deviation of parts, thereby the behavior of the recording medium may not become stable. For example, when the recording medium skews contrary to an intended direction, the direction of which the recording medium skews may not be determined. Thus, when the recording medium is guided from the feed unit to the reverse feed unit, the recording medium may be bent or jammed around a connection between the feed unit and the reverse feed unit.

More specifically, when the recording medium skews to the left side in the feed unit, the left end of the recording medium may contact an oblique-feed guide provided on the duplexer that constitutes the reverse feed unit, and there is a high possibility that the recording medium will be bent or jammed.

Aspects of the invention provide an image forming apparatus configured to form images on both sides of a recording medium, and may reduce undesired problems such as bending and jamming.

### BRIEF DESCRIPTION OF THE DRAWINGS

Illustrative aspects of the invention will be described in detail with reference to the following figures in which like elements are labeled with like numbers and in which:

FIG. 1 is a diagrammatic sketch of a color printer as an example of an image forming apparatus according to an illustrative embodiment;

FIG. 2 is a perspective view of a feed roller assembly;

FIG. 3 is a perspective view of a reverse feeder;

FIG. 4 is a top view of the reverse feeder;

FIG. 5 illustrates how a recording sheet is fed in a feed unit;

FIG. 6 illustrates how a recording sheet is fed in a feed unit of the color printer according to a second illustrative embodiment;

FIG. 7 illustrates a feed roller assembly according to another illustrative embodiment; and

FIGS. 8A and 8B each illustrate a structure of an ejection roller assembly according to still another illustrative embodiment.

### DETAILED DESCRIPTION

A first illustrative embodiment of the invention will be described in detail with reference to the accompanying drawings. Aspects of the invention are applied to an image forming apparatus, e.g. a color printer 1.

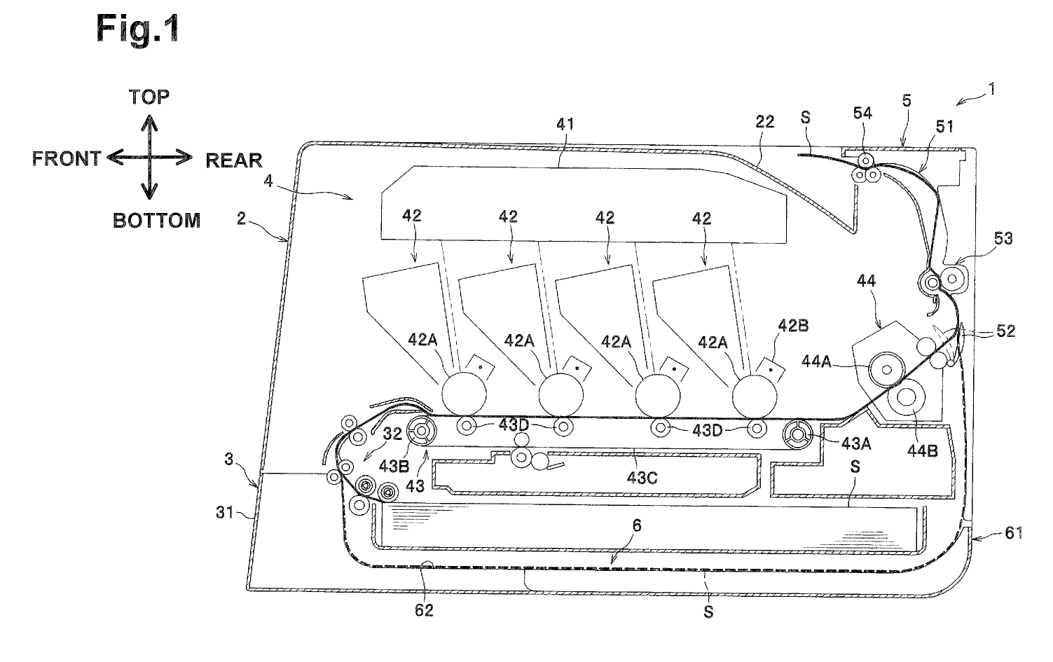

For ease of discussion, in the following description, sides of the color printer 1 will be referenced as viewed from a user in front of the color printer 1. Sides of individual objects of the color printer 1 will be similarly identified based on the arranged/attached position of the object on/in the color printer 1. In FIG. 1, the left hand is referred to as front or front side of the color printer 1 and the right hand is referred to as rear or rear side of the color printer 1.

The general structure of the color printer 1 will be described with reference to FIG. 1.

As shown in FIG. 1, the color printer 1 is configured to form images on both sides of a recording medium, e.g. a recording sheet S, and mainly includes a body casing 2 forming an external appearance of the color printer 1, a sheet supply unit 3, an image forming unit 4, a feeding mechanism 5, and a reverse feeding portion 6. In the color printer 1, the recording media may include plain paper, cardboards, postcards, and transparency sheets.

The sheet supply unit 3 is disposed in a lower portion of the body casing 2, and includes a sheet supply tray 31 and a sheet supply mechanism 32. A recording sheet S stored in the sheet supply tray 31 is supplied by the sheet supply mechanism 32 toward the image forming unit 4.

The image forming unit 4 is configured to form an image on a recording sheet S, and includes an exposure device 41, a plurality of, e.g. four, process units 42, a transfer unit 43, and a fixing device 44.

The exposure device 41 is disposed in an upper portion of the body casing 2, and includes a laser light source, a polygon mirror, lenses, and reflecting mirror, which are not shown. A laser beam emitted from the laser light source, based on image data, may be deflected by the polygon mirror, pass through the lenses, and be folded by the reflecting mirror to be directed to a surface of each of photosensitive drums 42A by high-speed scanning.

The process units 42 are disposed between the sheet supply tray 31 and the exposure device 41 and arranged in tandem in the front-rear direction. Each process unit 42 includes a photosensitive drum 42A, a charger 42B, and a developing roller, a supply roller, and a toner storing portion, which are not shown. The process units 42 are identical in structure but store different color toner in the toner storing portion.

The transfer unit 43 is disposed between the sheet supply tray 31 and the process units 42, and includes a drive roller 43A, a driven roller 43B, an endless belt 43C extending between the drive roller 43A and the driven roller 43B, and a plurality of, e.g. four, transfer rollers 43D. The endless belt 43C contacts the photosensitive drums 42A at its outer surface and contains inside the transfer rollers 43D such that the endless belt 43C is sandwiched between the transfer rollers 43D and the photosensitive drums 42A.

The fixing device 44 is disposed at the rear of the process units 42, and includes a heat roller 44A and a pressure roller 44B, which is disposed facing the heat roller 44A and configured to press the heat roller 44A.

In the image forming unit 4, the surfaces of the photosensitive drums 42A are uniformly charged by the respective chargers 42B and then exposed to laser beams (indicated by alternate long and short dashed lines) emitted from the exposure device 41, so that electrostatic latent images corresponding to image data are formed on the surfaces of the photosensitive drums 42A. Toner stored in the toner storing portions is supplied to the electrostatic latent images on the surfaces of the photosensitive drums 42A via the supply rollers and the developing rollers, and the latent images become visible and toner images are formed on the surfaces of the photosensitive drums 42A.

When the recording sheet S supplied from the sheet supply unit 3 is fed between the photosensitive drums 42A and the endless belt 43C (or transfer rollers 43D), the toner images formed on the surfaces of the photosensitive drums 42A are sequentially transferred and overlaid one over the other on the recording sheet S. The recording sheet S is fed between the heat roller 44A and the pressure roller 44B, so that the toner images transferred onto the recording sheet S are thermally fixed on the recording sheet S, and an image is formed on the recording sheet S.

The feeding mechanism 5 includes a feeding portion 51, a flapper 52 configured to pivot in the front-rear direction, a feed roller assembly 53, and an ejection roller 54, which is an example of a switchback roller.

The feeding portion 51 is configured to guide the recording sheet S fed from the image forming unit 4 toward the ejection roller 54 and also guide the recording sheet S from the ejection roller 54 toward the reverse feeding portion 6 when images are to be formed on both sides of the recording sheet S. The feeding portion 51 is disposed at the rear in the body casing 2 such that it extends generally vertically.

The feed roller assembly 53 is disposed in the feeding portion 51 and is configured to feed the recording sheet S in the feeding portion 51. The feed roller assembly 53 includes rollers that are configured to rotate bidirectionally. The feed roller assembly 53 feeds the recording sheet S upward toward the ejection roller 54 during forward rotation, and downward toward the reverse feeding portion 6 during reverse rotation.

The ejection roller 54 is disposed in an upper portion of the image forming unit 4 (specifically above the fixing device 44). The ejection roller 54 is configured to rotate bidirectionally. The ejection roller 54 is configured to eject the recording sheet S, which is fed from the fixing device 44 of the image forming unit 4, toward outside of the body casing 2 during forward rotation and switch back the recording sheet or draw the recording sheet S inside the body casing 2 during reverse rotation.

In the feeding mechanism 5, a recording sheet having an image formed on a single side only or on each side is ejected onto an output tray 22 by the feed roller assembly 53 and the ejection roller 54 which rotate forward.

When images are formed on both sides of a recording sheet S, after an image is formed on a first surface of the recording sheet S, through a known controller, the flapper 52 is caused to pivot toward the front and the ejection roller 54 reverses before the trailing end of the recording sheet S is completely ejected from the ejection roller 54. Then, the recording sheet S is guided to the feeding portion 51 by the ejection roller 54 that reverses, and fed to the reverse feeding portion 6 by the feed roller assembly 53 that reverses. The flapper 52 pivots toward the rear after the recording sheet S passes through the feeding portion 51.

The reverse feeding portion 6 is disposed in a lower portion of the body casing 2. The reverse feeding portion 6 is configured to guide the recording sheet S (indicated by a broken line), which is guided from the feeding portion 51, toward the image forming unit 4 when an image is formed on the second surface of the recording sheet (at this time, the ejection roller 54 is rotating in the reverse direction).

More specifically, the reverse feeding portion 6 is disposed under the image forming unit 4 and the sheet supply tray 31 and extends in the front-rear direction which is different from the feeding portion 51 that extends generally vertically. As the reverse feeding portion 6 is disposed such that its rear end adjoins to the feeding portion 51, the recording sheet S can be guided directly from the feeding portion 51 to the reverse feeding portion 6.

The reverse feeding portion 6 is mainly defined by a reverse feeder 61 and a guide wall 62 disposed inside the body casing 2.

The recording sheet S is fed from the feeding portion 51 to the reverse feeding portion 6. The recording sheet S is then fed again to the image forming unit 4 such that a second surface opposite to a first surface on which an image has been formed faces the photosensitive drums 42A. After an image has been formed on the second surface, the recording sheet S is ejected onto the output tray 22 by the feed roller assembly 53 and the ejection roller 54 which rotate forward.

A detailed structure of the feed roller assembly 53 will be described. In this illustrative embodiment, a first side in the widthwise direction (left-right direction) of a recording sheet S is referred to as the right side, and a second side, opposite to the first side in the widthwise direction is referred to as the left side.

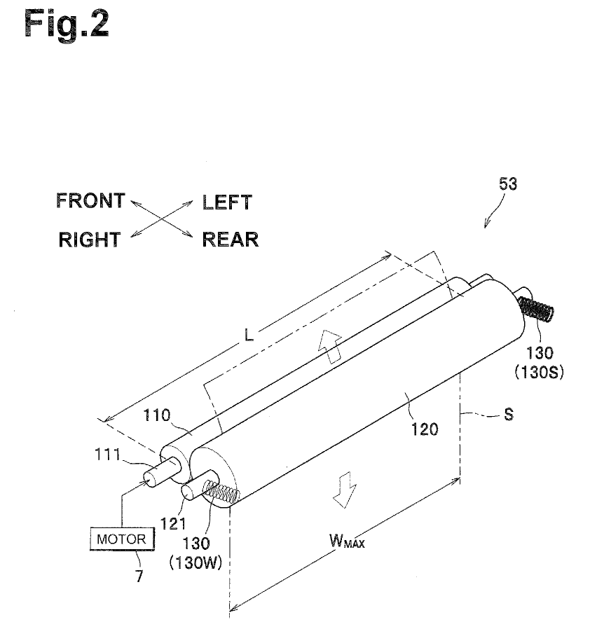

As shown in FIG. 2, the feed roller assembly 53 includes a pair of rollers, which are a drive roller 110 and a driven roller 120.

The drive roller 110 and the driven roller 120 have a length L of a roller portion in the left-right direction (a widthwise direction of a recording sheet S) which is greater than the maximum width Wmax of a recording sheet S on which the color printer 1 is configured to form an image. Thus, the recording sheet S is fed in contact with the feed roller assembly 53 (the drive roller 110 and the driven roller 120) across the full width.

The drive roller 110 is an anterior roller of the feed roller assembly 53, and is configured to rotate in response to an input of a driving force directly from a motor 7 disposed inside the body casing 2 or via gears, which are not shown.

The driven roller 120 is a posterior roller of the feed roller assembly 53 and is urged toward the drive roller 110 by urging members, e.g. springs 130, which are disposed on both ends of the driven roller 120. More specifically, the springs 130 are disposed on both ends of a shaft 121 of the driven roller 120, the shaft 121 is urged toward a shaft 111 of the drive roller 110, and the driven roller 120 is urged toward the drive roller 110.

With this structure, the drive roller 110 and the driven roller 120 of the feed roller assembly 53 are pressed against each other. The feed roller assembly 53 is configured such that as the drive roller 110 rotates, it drives the driven roller 120 to rotate.

Of the two springs 130, the spring 130W disposed on the right end of the shaft 121 imparts an urging force smaller than the spring 130S disposed on the left end of the shaft 121. Thus, in the feed roller assembly 53, a nip pressure on the right side is smaller than a nip pressure on the left side. In this embodiment, the nip pressure on the left side is 1.2-3.0 times, preferably 1.5-2.5 times, greater than the nip pressure on the right side.

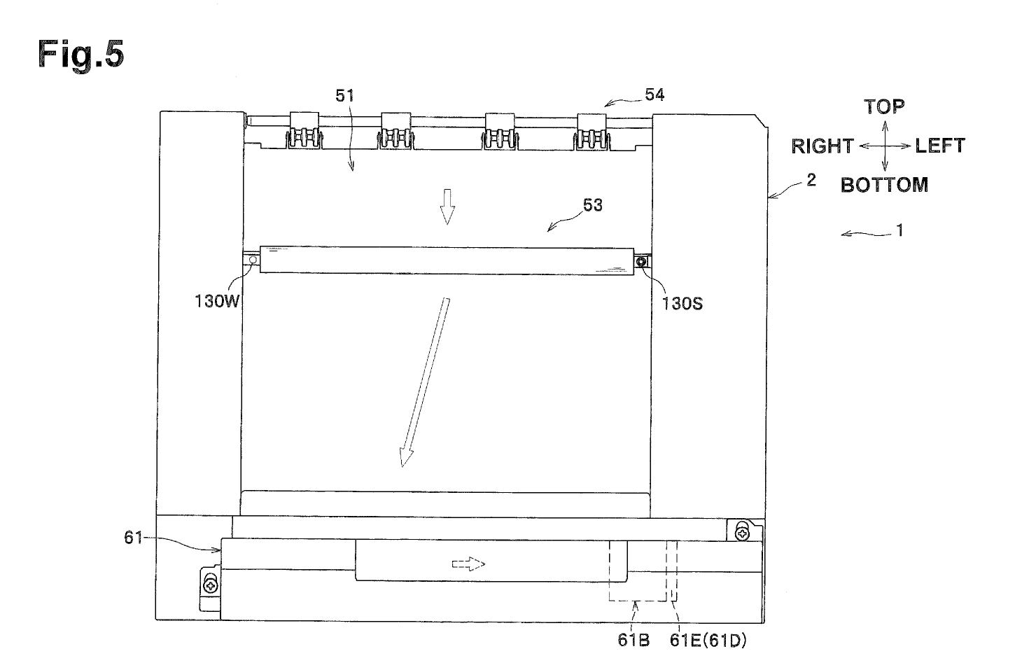

With the feed roller assembly 53 structured above, the left end of the recording sheet S is subjected to a greater nip pressure than the right end of the recording sheet S is. Thus, as the left end of the recording sheet S is fed stronger than the right end, the recording sheet S is fed in the feeding portion 51 so as to skew to the right side. In other words, the feed roller assembly 53 feeds the recording sheet S in the feeding portion 51 while moving or drawing it to the right side (FIG. 5).

A structure of the reverse feeder 61 will be described.

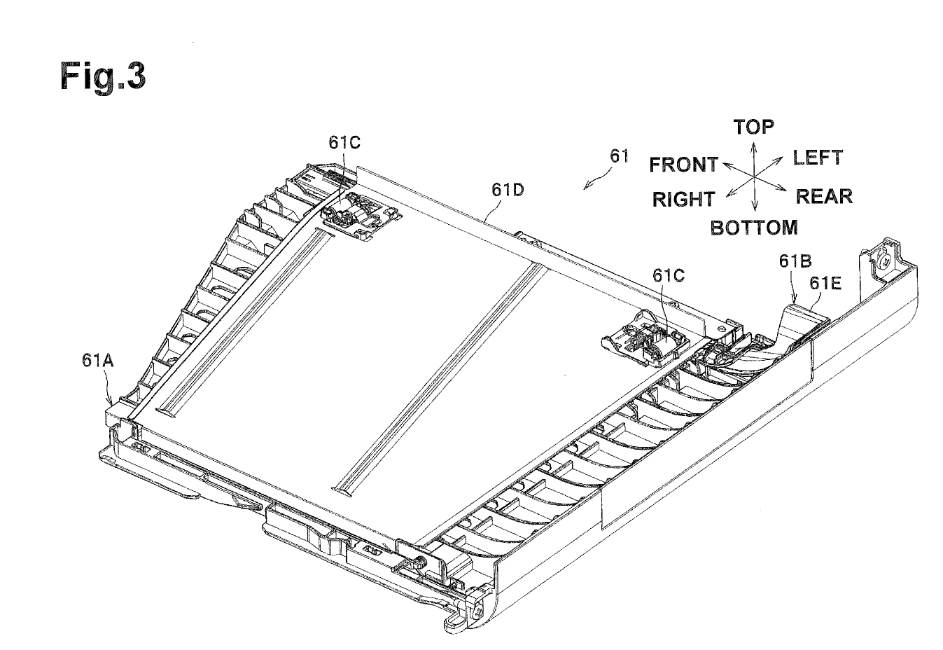

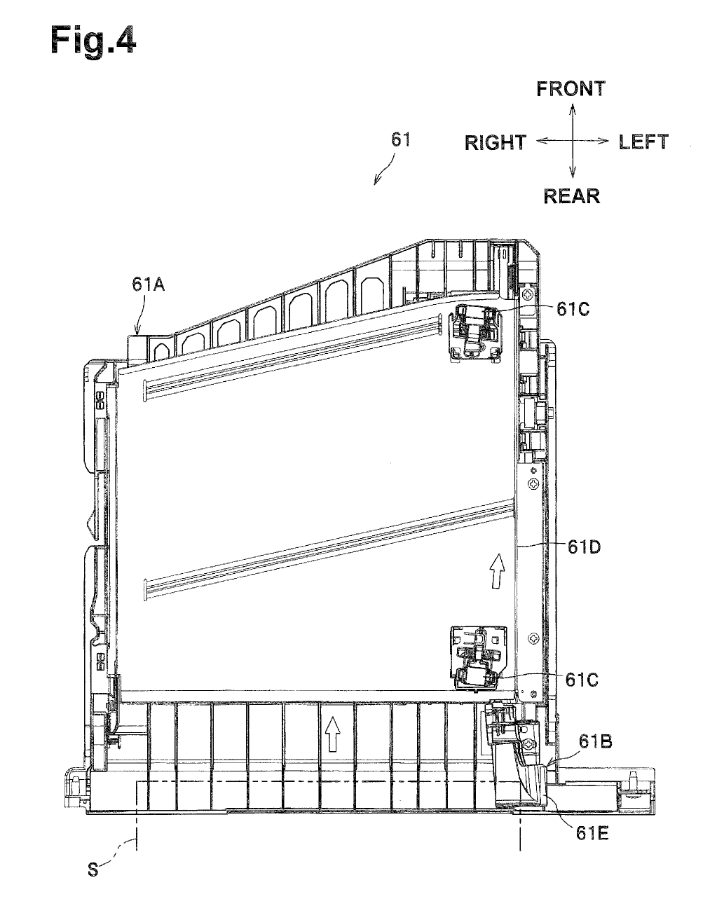

As shown in FIGS. 3 and 4, the reverse feeder 61 constitutes a part of a wall defining the reverse feeding portion 6, and mainly includes a feed tray 61A, a guide portion 61B, diagonal feed rollers 61C, and a restriction wall 61D as an example of a position restriction member.

The feed tray 61A constitutes a guide surface for guiding the recording sheet S (which is a lower wall of the reverse feeding portion 6) and has a width greater than the maximum width Wmax of a recording sheet S on which the color printer 1 is configured to form an image. The feed tray 61A may be detachably attached to the body casing 2.

The guide portion 61B is disposed on a left rear end portion of the feed tray 61A, which connects to the feeding portion 51. The guide portion 61B is configured to guide a corner of the left end of the recording sheet S (indicated by a chain double-dashed line in FIG. 4), which is fed by the feeding portion 51, toward the restriction wall 61D. When the corner of the left end of the recording sheet S contacts the guide portion 61B, the recording sheet S is moved to the right side.

The diagonal feed rollers 61C are configured to feed the recording sheet S while moving the recording sheet S to the left on the feed tray 61A within the reverse feeding portion 6. The diagonal feed rollers 61C are disposed so as to incline slightly to the left side in the sheet feeding direction (in the front-rear direction).

The restriction wall 61D is disposed on the left side of the feed tray 61A and extends in the front-rear direction. The restriction wall 61D is configured to restrict the left end of the recording sheet S from moving past a position toward the left side, which is moved to the left side by the diagonal feed rollers 61C. When the recording sheet S contacts the restriction wall 61D, the recording sheet S is restricted from moving past a position toward the left side or positioned in the widthwise direction and then fed toward the image forming unit 4.

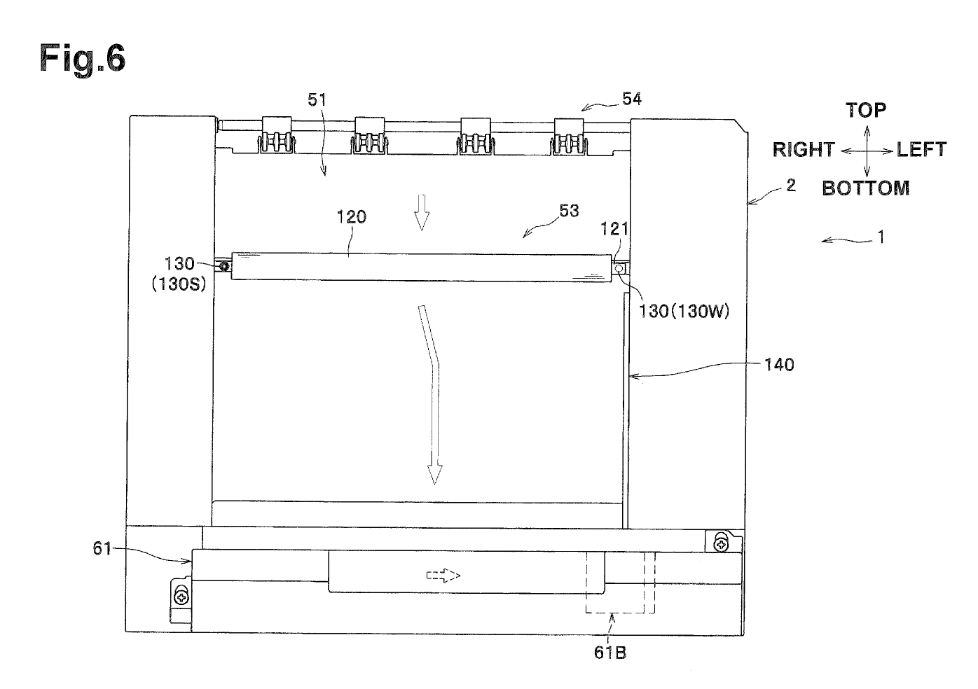

According to the color printer 1 of the illustrative embodiment structured above, the following advantages can be obtained. It is noted that FIGS. 5 and 6 illustrate the color printer 1 viewed from the rear but a rear wall of the body casing 2 is omitted for convenience in description.

The color printer 1 includes the feed roller assembly 53, which is disposed in the feeding portion 51 and structured that the nip pressure on the left end is greater than the nip pressure on the right end. The feed roller assembly 53 is configured to feed the recording sheet S in the feeding portion 51 while forcibly drawing it to the right side. With the feed roller assembly 53, the recording sheet S is fed in the feeding portion 51 while being drawn to the right side. This structure can reduce problems due to unstable behavior of the recording sheet S in the feeding portion 51, such as bending and paper jamming.

As shown in FIG. 5, the guide portion 61B for guiding the corner of the left end of the recording sheet S, which is fed by the feeding portion 51, is disposed at the end portion of the reverse feeder 61 or the reverse feeding portion 6, which connects to the feeding portion 51. By the diagonal feed rollers 61C, the recording sheet S is fed in the reverse feeding portion 6 while being drawn to the left side (in the direction of an arrow indicated by a broken line). With this structure, as the feed roller assembly 53 feeds the recording sheet S by moving it toward the right in the feeding portion 51 (in the direction of an arrow indicated by a solid line in FIG. 5), the left end of the recording sheet S can be moved inside (to the right side) further than a sidewall 61E of the guide portion 61B. This structure can reduce a chance of the left end of the recording sheet S contacting the sidewall 61E of the guide portion 61B, thereby reducing undesired problems such as bending and paper jamming.

The recording sheet S is once moved to the right side by the feed roller assembly 53 and then fed into the reverse feeding portion 6 (the reverse feeder 61) without making contact with the sidewall 61E of the guide portion 61B. The recording sheet S is moved to the left side in the reverse feeding portion 6 by the diagonal feed rollers 61C and accurately positioned with respect to the widthwise direction by the restriction wall 61D. After being positioned with respect to the widthwise direction in the reverse feeding portion 6, the recording sheet S is fed to the image forming unit 4 again such that a surface having no image faces the photosensitive drums 42A, and an image is formed on the surface in the image forming unit 4. At this time, the image can be formed in a correct position on the recording sheet S.

As the recording sheet S can be stably fed in the feeding portion 51 by moving the recording sheet S to the right side, the position of the recording sheet S that is just about to be guided to the reverse feeding portion 6 can be determined. The feeding portion 51 and the reverse feeding portion 6 (the reverse feeder 61) have narrower widths than prior designs which were kept for reducing the problems such as bending and paper jamming. Thus, the reverse feeder 61 and the laser printer 1 are compact in size compared with the prior designs.

As the length L of the feed roller assembly 53 is greater than the maximum width Wmax of the recording sheet S on which the color printer 1 is configured to form an image, the two springs 130 that urge the driven roller 120 toward the drive roller 110 can be disposed outside the maximum width Wmax. With a structure where the urging force imparted by the right spring 130W is made smaller than that imparted by the left spring 130S, the nip pressure on the right side of the feed roller assembly 53 can be made smaller than that on the left side. In other words, as the length L of the feed roller assembly 53 is greater than the maximum width Wmax, the recording sheet S can be moved to the right side with the above simple structure.

The feed roller assembly 53, which is involved in feeding the recording sheet S in the feeding portion 51, is comprised of the rollers pressed against each other and has different nip pressures on both ends. Thus, the feed roller assembly 53 can reliably move the recording sheet S to the right side in the feeding portion 51 by making the nip pressure on the right end smaller than that on the left end in the feed roller assembly 53 in this embodiment.

To differentiate the nip pressures on both ends of the feed roller assembly 53, the spring 130W disposed on the right end of the shaft 121 and the spring 130S disposed on the left end have different urging forces. In this embodiment, the urging force imparted by the spring 130W is smaller than that imparted by the spring 130S. Thus, the recording sheet S can be reliably moved to the right side in the feeding portion 51, and a degree to which the recording sheet S is moved to the right side can be also adjusted within a certain range according to spring selection.

The invention is advantageous especially in a structure like the color printer 1 where the ejection roller 54 is disposed above the image forming unit 4 or the fixing device 44 and the reverse feeding portion 6 is disposed below the image forming unit 4. This is because, in such a structure, the feeding portion 51 becomes long and movement of the recording sheet S is less likely to be stable.

A second illustrative embodiment will be described. In the second illustrative embodiment, it is noted that elements similar to or identical with those described in the first embodiment are designated by similar numerals, and thus the description thereof can be omitted for the sake of brevity. In the second illustrative embodiment, one side of a recording sheet S in the widthwise direction is referred to as the left side.

The feed roller assembly 53 of the second embodiment is structured such that the urging force imparted by the spring 130W disposed on the left end of the shaft 121 of the driven roller 120 is set smaller than the urging force imparted by the spring 130S disposed on the right end. As the nip pressure on the left end is smaller than that on the right end, the feed roller assembly 53 feeds the recording sheet S in the feeding portion 51 while moving it to the left side as shown in FIG. 6. In this embodiment, the nip pressure on the right side is 1.2-3.0 times, preferably 1.5-2.5 times, greater than the nip pressure on the left side.

On the left side of the feeding portion 51, there is a position restriction member, e.g. a position restriction wall 140 having a predetermined width in the front-rear direction and extending generally vertically. The position restriction wall 140 is configured to restrict the position of the left end of the recording sheet S, which is moved to the left side by the feed roller assembly 53, so that the recording sheet S can be restricted from moving past a position in the left direction. The recording sheet S contacts the position restriction wall 140 thereby the position of the left end of the recording sheet S is restricted. The recording sheet S moved to the position restriction wall 140 (to the left) is guided to the reverse feeding portion 6 (the reverse feeder 61) by the guide portion 61B.

In the reverse feeding portion 6, the recording sheet S is moved to the left side by the diagonal feed rollers 61C and accurately positioned with respect to the widthwise direction by the restriction wall 61D. The recording sheet S is fed to the image forming unit 4 such that a surface having no image faces the photosensitive drums 42A, and an image is formed on the surface of the recording sheet S in the image forming unit 4.

The color printer 1 of the second embodiment is structured such that the feed roller assembly 53 feeds the recording sheet S in the feeding portion 51 while forcibly moving it to the left side. Thus, the recording sheet S is fed in the feeding portion 51 such that it is always moved to the left side. This structure can reduce problems due to unstable movement of the recording sheet S in the feeding portion 51, such as bending and paper jamming.

In this embodiment, the position restriction wall 140, which is configured to restrict the position of the left end of the recording sheet S, is disposed in the feeding portion 51. Thus, the position of the recording sheet S can be determined to some degree with the feeding portion 51. This structure can reduce the amount of movement of the recording sheet S in the reverse feeding portion 6 compared with a structure for positioning the recording sheet S by moving it in the reverse feeding portion 6 only.

In the structure for moving the recording sheet S to the left side in the reverse feeding portion 6 only, the amount of movement of the recording sheet S in the reverse feeding portion 6 becomes great. Especially when the recording sheet S is thin, a crease may occur at some midpoint of the recording sheet S or a paper jam may occur in the reverse feeding portion 6. However, in this embodiment, the recording sheet S is gradually moved to the left side in both the feeding portion 51 and the reverse feeding portion 6, which can reduce a chance of such creasing and paper jamming.

In this embodiment, if the position of the recording sheet S is perfectly determined within the feeding portion 51, there is no need to move the recording sheet S in the reverse feeding portion 6. In this case, the reverse feeding portion 6 and the reverse feeder 61 may be structurally simplified. In addition, the width of the reverse feeding portion 6 (the reverse feeder 61) may be reduced by an allowance for the movement amount for moving the recording sheet S. Thus, the reverse feeder 61 and the color printer 1 can be compact in size.

The illustrative embodiments show, but the disclosure is not limited to, the nip pressure on one side of the feed roller assembly 53 in the widthwise direction being set smaller than that on the other side by making one of the two springs 130 that urge the driven roller 120 toward the drive roller 110 being set smaller than that of the other one.

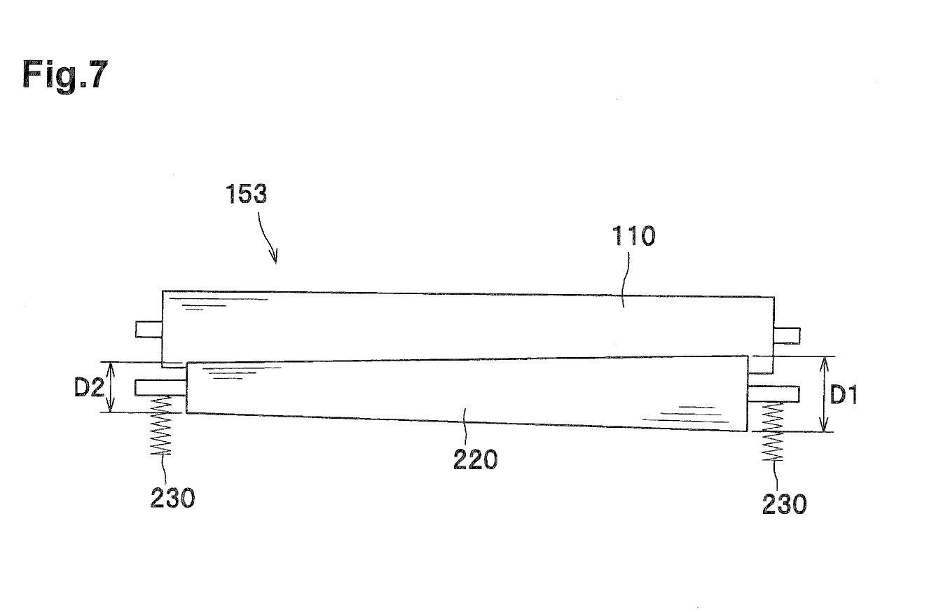

For example, a feed roller assembly 153 shown in FIG. 7 may be used instead. The feed roller assembly 153 includes a driven roller 220 having a diameter smaller toward one side in the widthwise direction than the other side in the widthwise direction (D1>D2). In FIG. 7, two springs 230 that urge the driven roller 220 toward the drive roller 110 are equal in urging force. Even in the feed roller assembly 153, the nip pressure on one side in the widthwise direction can be set smaller than that on the other side.

Instead of the driven roller 220, the drive roller 110 may be formed such that its diameter becomes smaller toward one side in the widthwise direction. Alternatively, both the drive roller 110 and the driven roller 220 may be formed such that their diameters become smaller toward one side in the widthwise direction.

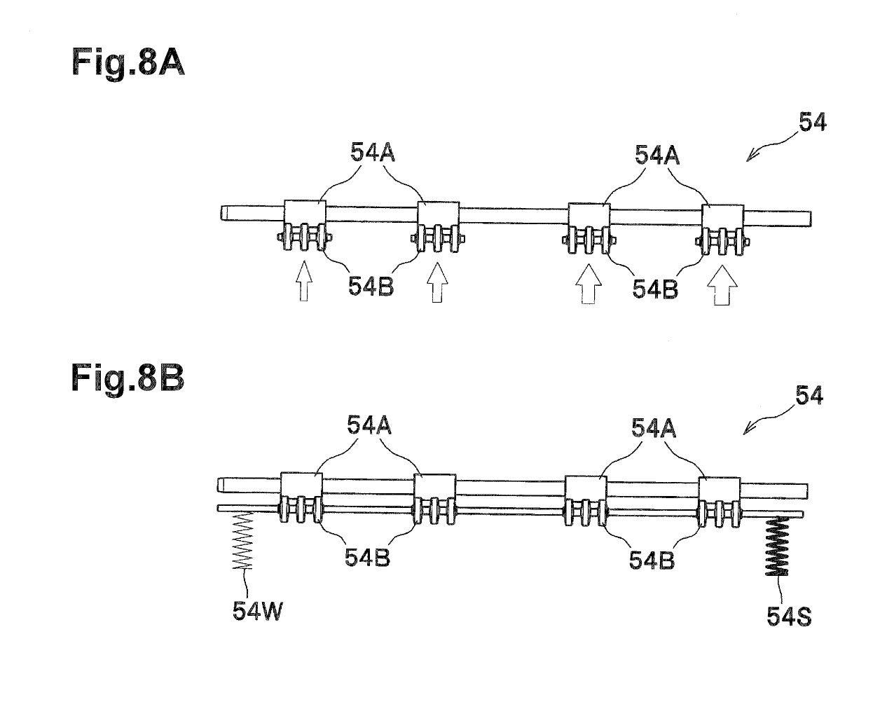

The illustrative embodiments show, but the disclosure is not limited to, the recording sheet S being fed and moved to one side in the widthwise direction only by the feed roller assembly 53, 153. The ejection roller 54 may be used together with the feed roller assembly 53, 153. For example, as shown in FIG. 8A, the ejection roller 54 may be comprised of a plurality of drive rollers 54A mounted on a shaft, and a plurality of driven rollers 54B, which are provided in association with and individually urged against each driven roller 54A. In this structure, by reducing an urging force (indicated by arrows) of a component that urges the driven rollers 54B against the drive rollers 54A gradually toward one side in the widthwise direction, the nip pressure for the recording sheet S can be gradually reduced in the widthwise direction of the recording sheet S. As a result, the recording sheet S can be fed while being moved to one side in the widthwise direction.

Alternatively, as shown in FIG. 8B, the ejection roller 54 may be comprised of a plurality of drive rollers 54A mounted on a shaft, and a plurality of driven rollers 54B mounted on a shaft, and springs 54S, 54W disposed on both ends of the shaft of the driven rollers 54B. The springs 54S, 54W are configured to urge the driven rollers 54B against the drive rollers 54A. By making the urging force imparted by the spring 54W smaller than that imparted by the spring 54S, the recording sheet S can be fed while being moved to one side in the widthwise direction.

By combined use of the feed roller assembly 53, 153 and the ejection roller 54, the recording sheet S can be reliably moved to one side in the feeding portion 51. In addition, this combination can reduce the nip pressure to be produced at the ends of the feed roller assembly 53, 153, thereby reducing the possibility of abrasion of the feed roller assembly 53, 153, when compared with a structure where only the feed roller assembly 53, 153 is used to move the recording sheet S to one side in the feeding portion 51.

The ejection roller 54 may have the length in the widthwise direction which is greater than the maximum width Wmax of a recording sheet S on which the color printer 1 is configured to form an image. The ejection roller 54 may be configured not to feed the recording sheet S diagonally during forward rotation of the drive rollers 54A (at which the recording sheet is ejected outside the body casing 2). In other words, the ejection roller 54 may be configured to feed the recording sheet S while moving it to one side only during reverse rotation of the drive rollers 54A (at which the recording sheet is fed in the feeding portion 51 toward the reverse feeding portion 6).

The second embodiment shows but the disclosure is not limited to, the position restriction portion or member, e.g. the position restriction wall 140, being disposed in the feeding portion 51. The position restriction portion may be disposed in the feeding portion 51 in the first embodiment. Specifically, the position restriction portion, e.g. a wall, may be disposed on the right side of the feeding portion 51 (FIG. 5) and extend generally vertically. The recording sheet S moved to the right side by the feed roller assembly 53 may contact the position restriction portion, and the position of the right end of the recording sheet S can be restricted. This structure can reduce a possibility that the recording sheet S is moved to the right side more than necessary in the first embodiment.

The illustrative embodiments show, but the disclosure is not limited to, one feed roller assembly 53, 153 in the feeding portion 51. A plurality of feed roller assemblies may be provided in the feeding portion 51.

The illustrative embodiments show, but the disclosure is not limited to, the feed roller assembly 53, 153 being comprised of a pair of rollers. The feed roller assembly 53, 153 may be comprised of a single roller, which is, for example, pressed against the wall defining the feeding portion 51. This structure also can feed the recording sheet S to one side in the widthwise direction by setting the nip pressure on one side of the single roller in the widthwise direction smaller than that on the other side.

The illustrative embodiments show, but the disclosure is not limited to, the structure of the image forming unit 4. Instead of the exposure device 41 that emits laser beams to the photosensitive drums 42A, an exposure device may include a light source such as an array of light emitting diodes (LED), organic electroluminescence light-emitting elements or fluorescent light emitting elements. Instead of the fixing device 44 including the heat roller 44A and the pressure roller 44B, a fixing device of film fixing type may be used.

The illustrative embodiments show, but the disclosure is not limited to, the feeding portion 51 being configured to guide the recording sheet S both when an image is formed on a single-surface only and when images are formed on both surfaces. A portion that guides the recording sheet S when an image is formed on a single-surface only and a portion that guides the recording sheet S when images are formed on both surfaces may be separately provided, and the latter may be regarded as the feeding portion of the disclosure.

This illustrative embodiment shows, but is not limited to, the color printer 1. It will be appreciated that this illustrative embodiment also applies to other types of image forming apparatuses, an intermediate transfer type color printer, four-cycle color printer, and monochrome printer as well. In addition, the image forming apparatus is not limited to a printer, but may be a copier or a multi-function apparatus.

While the features herein have been described in connection with various example structures and illustrative aspects, it will be understood by those skilled in the art that other variations and modifications of the structures and aspects described above may be made without departing from the scope of the disclosures described herein. Other structures and aspects will be apparent to those skilled in the art from a consideration of the specification or practice of the features disclosed herein. It is intended that the specification and the described examples only are illustrative with the true scope of the disclosures being defined by the following claims.

What is claimed is:

1. An image forming apparatus configured to form images on both surfaces of a recording medium, comprising:
an image forming unit configured to form an image on a recording medium;
a switchback roller configured to switch back the recording medium fed from the image forming unit;
a first feeding portion configured to feed the recording medium switched back by the switchback roller, the first feeding portion including a feed roller assembly, the feed roller assembly being configured to feed the recording medium in a switchback direction while moving the recording medium to a first side in a widthwise direction perpendicular to the switchback direction; and
a second feeding portion configured to feed the recording medium fed by the first feeding portion toward the image forming unit while moving the recording medium, moved to the first side by the feed roller assembly, to a second side opposite to the first side in the widthwise direction.

2. The image forming apparatus according to claim 1, wherein the second feeding portion includes a position restriction member configured to restrict the recording medium from moving past a position toward the second side in the widthwise direction.

3. The image forming apparatus according to claim 1, wherein the second feeding portion includes a guide portion, and the guide portion is configured to guide a corner of the recording medium, which is fed by the first feeding portion, toward the first side in the widthwise direction.

4. The image forming apparatus according to claim 1, wherein the feed roller assembly includes rollers which extend in the widthwise direction and are pressed against each other, a nip pressure between the rollers on the first side of the feed roller assembly in the widthwise direction being smaller than a nip pressure between the rollers on the second side.

5. The image forming apparatus according to claim 4,
wherein the feed roller assembly includes urging members, the urging members being disposed on the first side and the second side of a first one of the rollers in the widthwise direction and configured to urge the first one of the rollers toward a second one of the rollers, and
wherein a first urging member disposed on the first side of the first one of the rollers in the widthwise direction imparts an urging force that is smaller than an urging force imparted by a second urging member disposed on the second side in the widthwise direction.

6. The image forming apparatus according to claim 5, wherein the urging force imparted on the first one of the rollers by the second urging member is 1.2-3.0 times greater than the urging force imparted on the first one the rollers by the first urging member.

7. The image forming apparatus according to claim 5, wherein the urging force imparted on the first one of the rollers by the second urging member is 1.5-2.5 times greater than the urging force imparted on the first one of the rollers by the first urging member.

8. The image forming apparatus according to claim 1, wherein the feed roller assembly includes rollers which extend in the widthwise direction and are pressed against each other, at least one of the rollers having a diameter which decreases from the second side of the roller toward the first side of the roller in the widthwise direction.

9. The image forming apparatus according to claim 1, wherein the switchback roller is configured to feed the recording medium while moving the recording medium to the first side in the widthwise direction.

10. The image forming apparatus according to claim 1,
wherein the switchback roller is disposed above the image forming unit, and
wherein the second feeding portion is disposed below the image forming unit.

11. The image forming apparatus according to claim 1, wherein the switchback roller is configured to eject the recording medium after the image forming unit has formed images on both surfaces of the recording medium.

12. The image forming apparatus according to claim 1, wherein the feed roller assembly is configured to feed the recording medium toward the switchback roller.

13. The image forming apparatus according to claim 1, wherein the feed roller assembly has a length greater than a maximum width of the recording medium on which the image forming apparatus is configured to form an image.

14. An image forming apparatus configured to form an image on both sides of a recording medium, comprising:
an image forming unit configured to form an image on a recording medium;
a switchback roller configured to switch back the recording medium fed from the image forming unit;
a first feeding portion configured to feed the recording medium switched back by the switchback roller, the first feeding portion including:
a feed roller assembly configured to feed the recording medium in a switchback direction while moving the recording medium to a first side in a widthwise direction perpendicular to the switchback direction; and
a first position restriction member configured to restrict the recording medium from moving past a position toward the first side in the widthwise direction; and
a second feeding portion configured to feed the recording medium restricted by the first position restriction member toward the image forming unit.

15. The image forming apparatus according to claim 14, wherein the second feeding portion includes a second position restriction member configured to restrict the recording medium from moving past a position toward the first side in the widthwise direction.

16. The image forming apparatus according to claim 14, wherein the second feeding portion includes a guide portion, and the guide portion is configured to guide a corner of the recording medium, which is fed by the first feeding portion, toward a second side opposite the first side in the widthwise direction.

17. The image forming apparatus according to claim 14, wherein the feed roller assembly includes rollers which extend in the widthwise direction and are pressed against each other, and a nip pressure between the rollers on the first side of the feed roller assembly in the widthwise direction being smaller than a nip pressure between the rollers on the second side.

18. The image forming apparatus according to claim 17,
wherein the feed roller assembly includes urging members, the urging members being disposed on the first side and the second side of a first one of the rollers in the widthwise direction and configured to urge the first one of the rollers toward a second one of the rollers,
wherein a first urging member disposed on the first side of the first one of the rollers in the widthwise direction imparts an urging force that is smaller than an urging force imparted by a second urging member disposed on the second side in the widthwise direction.

19. The image forming apparatus according to claim 14, wherein the switchback roller is configured to eject the recording medium after the image forming unit has formed images on both surfaces of the recording medium.

20. The image forming apparatus according to claim 14, wherein the feed roller assembly is configured to feed the recording medium toward the switchback roller.
